(19) United States
(12) Patent Application Publication
(10) Pub. No.: US 2004/0205651 A1
(43) Pub. Date: Oct. 14, 2004

(54) Transferring information over a network related to the content of user's focus

(75) Inventors: Rabindranath Dutta, Austin, TX (US); Janani Janakiraman, Austin, TX (US); David B. Kumhyr, Austin, TX (US)

Correspondence Address: Kelly K. Kordzik, 5400 Renaissance Tower, 1201 Elm Street, Dallas, TX, 75270, US

(73) Assignee: International Business Machines Corporation, Armonk, NY

(21) Appl. No.: 09/951,953

(22) Filed: Sep. 13, 2001

(51) Int. Cl. G06F 15/00

(52) U.S. Cl. 715/530; 715/501.1

(57) ABSTRACT

A method, system and computer program product for transferring advertisements and/or specific information over a network. A server may transmit an application that may comprise a Java applet to a client where the application may be configured to track and detect the user of the client focusing on a portion, i.e., a particular area or particular word(s), in a document. The application may determine if there are any components, e.g., terms, in the portion of the document focused by the user in a list of components that have an advertisement and/or specific information associated with the components. If there are any components in the list focused on by the user, then the application may map each of the identified components, e.g., terms, to a particular file storing an advertisement and/or specific information. The application may transmit a request to the server to transmit those particular file(s) identified to the client.

### TECHNICAL FIELD

The present invention relates to the field of distribution information systems, and more particularly to transferring advertisements and/or specific information related to the content of a user's focus via a network.

### BACKGROUND INFORMATION

The development of computerized distribution information systems, such as the Internet, allows users to link with servers and networks, and thus retrieve vast amounts of electronic information that was previously unavailable using conventional electronic mediums. Such electronic information increasingly is replacing the more conventional means of information such as newspapers, magazines and television.

Users may be linked to the Internet through a hypertext system of servers commonly referred to as the World Wide Web (WWW). With the World Wide Web, an entity having a domain name may create a “web page ” or “page ” that can provide information and some interactivity.

A computer user may “browse ” , i.e. navigate around, the WWW by utilizing a suitable web browser, e.g., Netscape Navigator™, Internet Explorer™, and a network gateway, e.g., Internet Service Provider (ISP). A web browser allows the user to specify or search for a web page on the WWW and subsequently retrieve and display web pages on the user's computer screen. Such web browsers are typically installed on personal computers or workstations to provide web client services, but increasingly may be found on wireless devices such as cell phones, Personal Digital Assistant's (PDA's), etc.

The Internet is based upon a suite of communication protocols known as Transmission Control Protocol/Internet Protocol (TCP/IP) which sends packets of data between a host machine, e.g., server computer on the Internet commonly referred to as web server, and a client machine, e.g., a user's computer connected to the Internet. The WWW is a network of computers that use an Internet interface protocol which is supported by the same TCP/IP transmission protocol suite for the communication of document files typically formatted in a markup language, such as the Hypertext Markup Language (HTML).

A user upon reading information in a document, e.g., e-mail, web page, displayed on a computer screen may wish to obtain further information related to a particular word, e.g., soccer, read in the document. An application called QuickClick™ may provide the user with a link to web resources on selected words in the document, e.g., e-mail, web page, read by the user. The words with links to web resources may be indicated by a yellow underline beneath the word in the document. The user may then click on the yellow underline beneath the word of interest to receive a menu of links to web resources, e.g., advertisements. In an alternative embodiment, the user may press the ALT key while clicking on the word of interest if the word does not have a yellow underline beneath it in order to receive, if any, a menu of links to web resources, e.g., advertisements, related to the selected word.

In order for the user to receive a menu of links to web resources, e.g., advertisements, the user must select the word or yellow underline beneath the word in the document read. However, the user may desire to receive advertisements and/or specific information related to the content of the user's focus which may not be a particular word but the content of a particular area within the document. Furthermore, the user may desire to receive advertisements and/or specific information related to the content of the user's focus without having to manually select a word of interest. Additionally, the provider of the document may want to send information in response to a user's focus on a portion of the document without requiring user action.

It would therefore be desirable to have systems and methods to transfer selected context related information such as advertisements or other information related to the content of a user's focus via a network without the user selecting a particular word of interest.

### SUMMARY

The problems outlined above may at least in part be solved in some embodiments by a server transmitting an application that may comprise a Java applet to a client where the application may be configured to track and detect the user of the client focusing on a portion, such as a particular area or particular word(s), in a document. The application may then determine if there are any components, e.g., terms, in the portion of the document focused on by the user that are in a list of components that have an advertisement and/or specific information associated with the components. If there are any components in the list focused on by the user, then the application may map each of the identified components, e.g., terms, to a particular file storing an advertisement and/or specific information. The application may transmit a request to the server to transmit those particular file(s) identified to the user of the client. The server may be configured to transmit those particular file(s) storing selected contextual information such as advertisement(s) or other specific information to the client. The particular file(s) may be parsed by the browser of the client in order to display the images and graphics on a display as well as generate audio, if any, through speakers. The images and graphics as well as any audio may include context related advertisement(s) or other information related to the content of the user's focus.

In one embodiment of the present invention, a method for transferring context related information related to the content of a user's focus may comprise the step of a server transmitting a file to a client. The file may then be parsed by a browser of the client in order to display the images and graphics of a document, e.g., web page, picture, on a display of the client as well as generate any audio through speakers. The server may then transmit an application that may comprise a Java applet to the browser of the client. The application may be configured to provide functionality to the document viewed as well as store a list of one or more components, e.g., terms, in the document, e.g., web page, picture, displayed by the client related to an advertisement and/or specific information. The list of one or more components may be stored locally or remotely to the server.

The application may be further configured to track the focus of the user of the client in the document. In one embodiment, the application may embody code to perform tracking based on the movement of a mouse. In another embodiment, the application may embody code to perform tracking based on the area of text that may be zoomed by the user of the client using screen magnification software stored locally on the client. In another embodiment, the application may embody code to perform tracking based on a Charge Coupled Device (CCD) camera coupled to the client. In another embodiment, the application may embody code to perform tracking based on the CCD camera coupled to the client and eye tracking software stored locally on the client.

The application may further be configured to detect the user of the client focusing on a particular portion, for example a particular area or a particular word(s) in the document, e.g., web page, picture, displayed on a display of the client. In one embodiment, the application may determine that the user of the client is focusing on a portion in the document based on the duration of time the user is focusing on the portion. In another embodiment, the application may determine that the user of the client is focusing on a portion in the document based on the user of the client zooming on a portion using screen magnification software stored locally on the client.

Upon detecting the user focusing on a portion of the document, the application may further be configured to search through the list of one or more components, e.g., terms, to determine if there are components in the portion focused on by the user of the client that are in the list. If there is not a component, e.g., term, in the portion focused on by the user of the client in the list, then the application may be configured to continue to track the focus of the user of the client.

If there are one or more components, e.g., terms, in the portion focused on by the user of the client in the list, then the application may identify those one or more components in the portion focused on by the user of the client in the list. The application may map each of the identified one or more components, e.g., terms, to a particular file storing selected information. The application may transmit a request to the server to transmit the particular file(s) identified to the client.

The server may be configured to transmit the particular file(s) storing selected information to the client. The particular file(s) may be parsed by the browser of the client in order to display the images and graphics on a display as well as generate audio, if any, through speakers. The images and graphics as well as any audio are selected information related to the content of the user's focus.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system configured in accordance with the present invention;

FIG. 2 illustrates an alternative embodiment of the network system configured in accordance with the present invention;

FIG. 3 illustrates an embodiment of the present invention of a client in a network system;

FIG. 4 illustrates an embodiment of the present invention of the servers in both embodiments of the network systems;

FIG. 5 is a flowchart of a method for transferring selected information related to the content of a user's focus in accordance with the present invention; and

FIG. 6 is a flow diagram of a method for transferring selected information related to the content of a user's focus using the alternative embodiment of the network system in accordance with the present invention.

### DETAILED DESCRIPTION

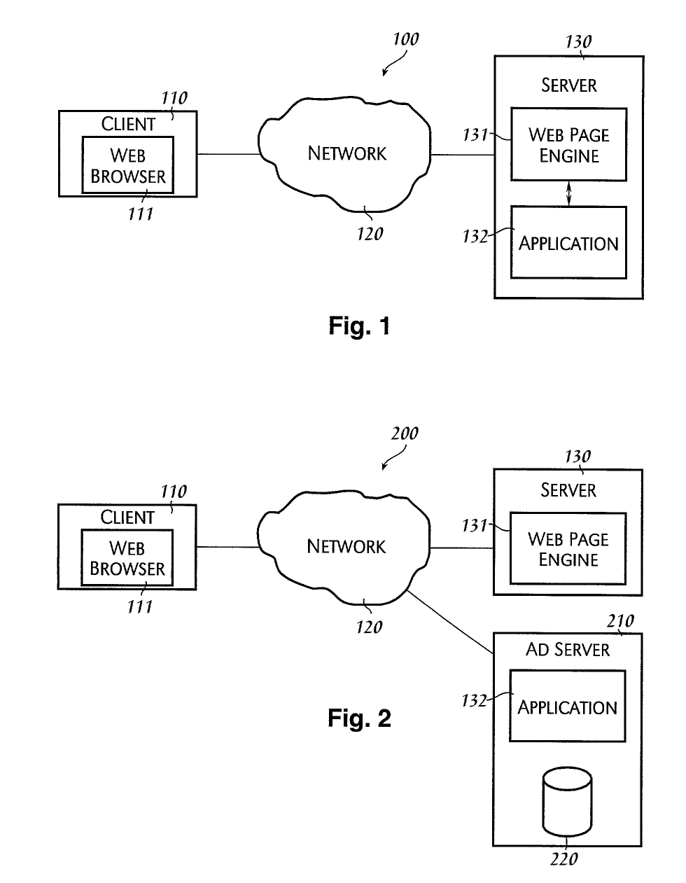

### FIG. 1—Network System

FIG. 1 illustrates an embodiment of the present invention of a network system 100. Network system 100 may comprise a client 110 connected to a server 130 via a network 120. Network 120 may be a Local Area Network (LAN), e.g., Ethernet, Token Ring, ARCnet, or a Wide Area Network (WAN), e.g., Internet. It is noted that the Internet may refer to a network of computers. It is further noted that the connection between client 110 and server 130 may be any medium type, e.g., wireless, wired. It is further noted that client 110 may be any type of device, e.g., wireless, Personal Digital Assistant (PDA), cell phone, personal computer system, workstation, Internet appliance, configured with the capability of connecting to network 120 and consequently communicating with server 130. It is further noted that network system 100 may be any type of system that has at least one server and at least one client and that FIG. 1 is not to be limited in scope to any one particular embodiment.

Server 130 may comprise a web page engine 131 for maintaining and providing access to an Internet web page which is enabled to forward web pages to a web browser 111 of client 110. Web pages are typically formatted as a markup language file, for example HyperText Markup Language (HTML) or Extended Markup Language (XML). Web page engine 131 may further be configured to forward an application 132 that may comprise a Java applet to web browser 111 of client 110 to add additional functionality to the web page viewed by user of client 110. Web browser 111 may be configured for reading and interpreting web pages. While the illustrated client engine is a web browser 111, those skilled in the art will recognize that other client engines may be used in accordance with the principles of the present invention.

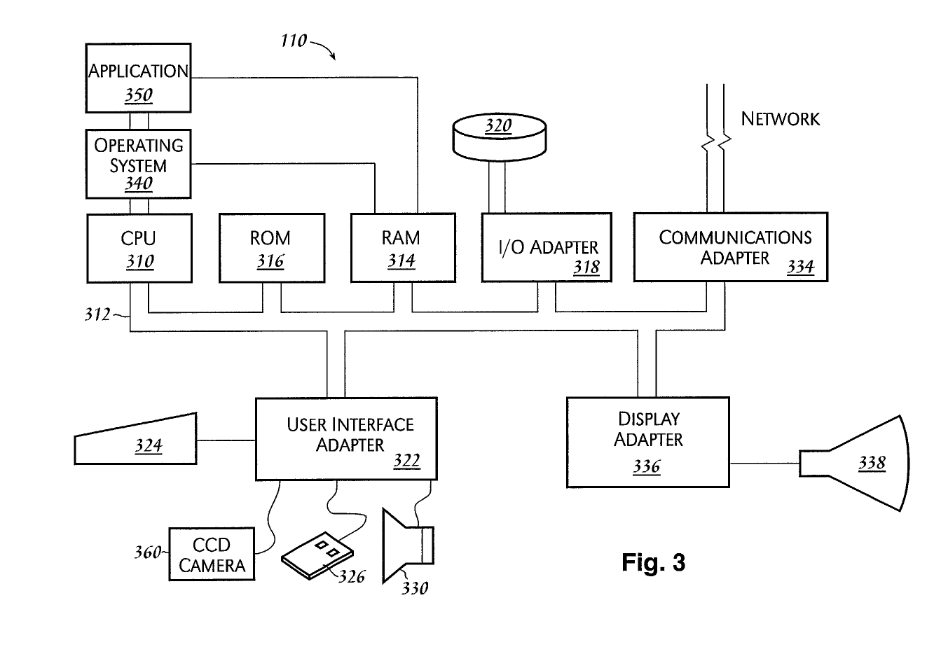

### FIG. 2—Alternative Embodiment of Network System

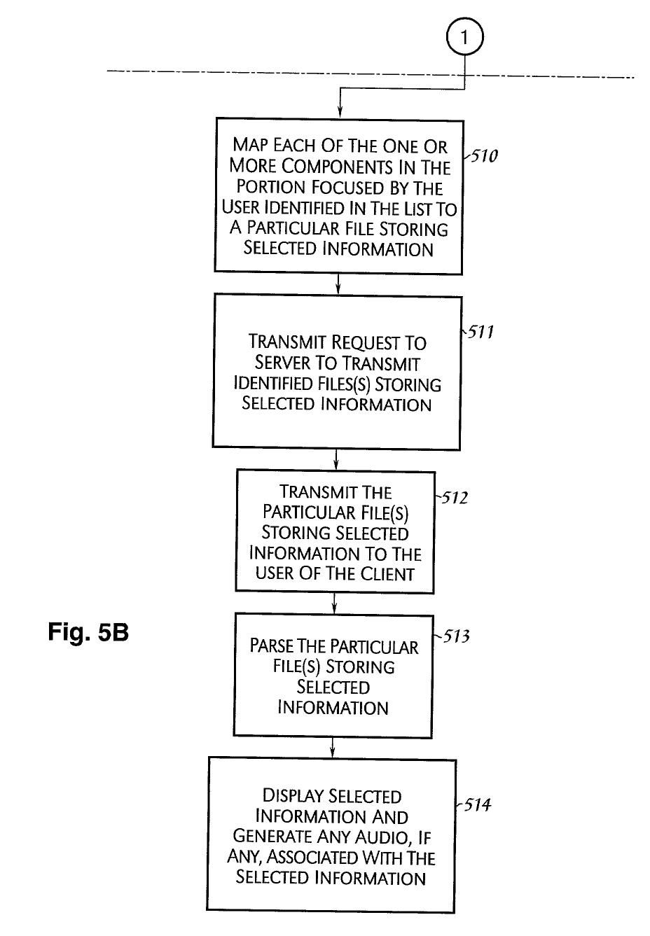

FIG. 2 illustrates an alternative embodiment of a network system in accordance with the present invention. Network system 200 may be configured as network 100 except that network system 200 may further comprise an advertising server 210 configured to transmit advertisement(s) and/or specific information stored in database 220 to client 110 as described in greater detail in conjunction with FIG. 5. Furthermore, application 132 that may comprise a Java applet may be forwarded to web browser 111 of client from server 210 instead of server 130. It is noted that network system 200 may be any type of system that comprises a server configured to transmit advertisement(s) and/or specific information as well as transmitting an application 132 that may comprise a Java applet and that FIG. 2 is not to be limited in scope to any one particular embodiment.

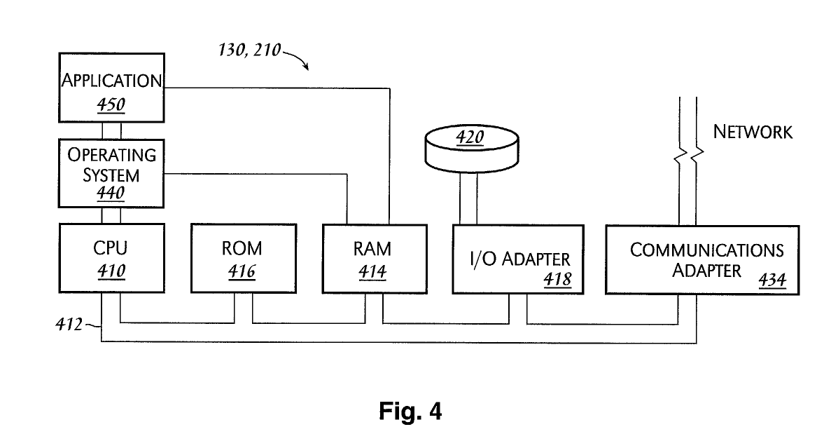

### FIG. 3—Hardware Configuration of Client

FIG. 3 illustrates a typical hardware configuration of client 110 which is representative of a hardware environment for practicing the present invention. Client 110 may comprise a central processing unit (CPU) 310 coupled to various other components by system bus 312. An operating system 340, runs on CPU 310 and provides control and coordinates the function of the various components of FIG. 3. Application 350, e.g., eye tracking software, screen magnification software, web browser 111, runs in conjunction with operating system 340 and provides output calls to operating system 340 which implements the various functions to be performed by the application 350. Read only memory (ROM) 316 may be coupled to system bus 312 and include a basic input/output system (“BIOS”) that controls certain basic functions of client 120. Random access memory (RAM) 314, I/O adapter 318, and communications adapter 334 may also be coupled to system bus 312. It should be noted that software components including operating system 340 and application 350 may be loaded into RAM 314 which is the computer system's main memory. I/O adapter 318 may be a small computer system interface (“SCSI”) adapter that communicates with disk unit 320, e.g., disk drive.

Communications adapter 334 interconnects bus 312 with an outside network 120 enabling client 110 to communicate with server 130 or server 210 via a Local Area Network (LAN), e.g., Ethernet, Token Ring, ARCnet, or a Wide Area Network (WAN), e.g., Internet. Input/Output devices may also be connected to system bus 312 via a user interface adapter 322 and a display adapter 336. Keyboard 324, mouse 326, speaker 330 and Charge Coupled Device (CCD) camera 360 may all be interconnected to bus 312 through user interface adapter 322. Event data may be inputted to client 110 through any of these devices. CCD camera 360 in conjunction with eye tracking software that may reside in application 350 may be configured to track the focus of a user in a document, e.g., web page, picture, displayed on a display 338. Display monitor 338 may be connected to system bus 312 by display adapter 336. In this manner, a user may be capable of inputting to client 110 through keyboard 324 or mouse 326 and receiving output from client 110 via display 338 or speaker 330.

Implementations of the invention include implementations as a computer system programmed to execute the method or methods described herein, and as a computer program product. According to the computer system implementations, sets of instructions for executing the method or methods are resident in the random access memory 314 of one or more computer systems configured generally as described above. Until required by client 110, the set of instructions may be stored as a computer program product in another computer memory, for example, in disk drive 320 (which may include a removable memory such as an optical disk or floppy disk for eventual use in disk drive 320). Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

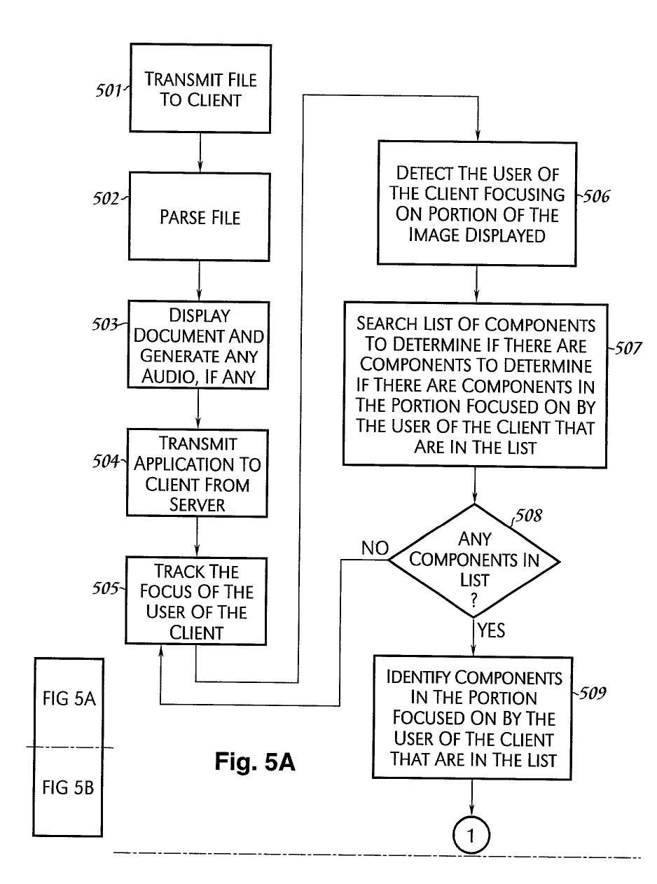

### FIG. 4—Hardware Configuration of Servers

FIG. 4 illustrates an embodiment of the present invention of server 130. FIG. 4 further illustrates an embodiment of the present invention of server 210. Referring to FIG. 4, servers 130, 210 may each comprise a central processing unit (CPU) 410 coupled to various other components by system bus 412. An operating system 440 runs on CPU 410 and provides control and coordinates the function of the various components of FIG. 4. Application 450, e.g., program for transferring advertisements and/or specific information by transferring application 132 to client 110 that may comprise a Java applet, as described in FIG. 5, runs in conjunction with operating system 440 which implements the various functions to be performed by application 450. Read only memory (ROM) 416 may be coupled to system bus 412 and include a basic input/output system (“BIOS”) that controls certain basic functions of servers 130, 210. Random access memory (RAM) 414, disk adapter 418 and communications adapter 434 may also be coupled to system bus 412. It should be noted that software components including operating system 440 and application 450 may be loaded into RAM 414 which is the computer system's main memory. Disk adapter 418 may be a small computer system interface (“SCSI”) adapter that communicates with disk units 420, e.g., disk drive. It is noted that the program of the present invention that transfers advertisements and/or specific information by transferring application 132 to client 110 that may comprise a Java applet, as described in FIG. 5, may reside in disk unit 420 or application 450. Communications adapter 434 interconnects bus 412 with an outside network 120 enabling servers 130, 210 to communicate with client 110 via a Local Area Network (LAN), e.g., Ethernet, Token Ring, ARCnet, or a Wide Area Network (WAN), e.g., Internet.

Implementations of the invention include implementations as a computer system programmed to execute the method or methods described herein, and as a computer program product. According to the computer system implementations, sets of instructions for executing the method or methods are resident in the random access memory 414 of one or more computer systems configured generally as described above. Until required by server 130, 210, the set of instructions may be stored as a computer program product in another computer memory, for example, in disk drive 420 (which may include a removable memory such as an optical disk or floppy disk for eventual use in disk drive 420). Furthermore, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

### FIG. 5—Method for Transferring Advertisements and/or Specific Information Related to the Content of User's Focus

FIG. 5 illustrates a flowchart of one embodiment of the present invention of a method 500 for transferring advertisements and/or specification information related to the content of user's focus. As stated in the Background Information section, a user upon reading information in a document, e.g., e-mail, web page, displayed on a computer screen may wish to obtain further information related to a particular word, e.g., soccer, read in the document. An application called QuickClick™ may provide the user with a link to web resources on selected words in the document, e.g., e-mail, web page, read by the user. The words with links to web resources may be indicated by a yellow underline beneath the word in the document. The user may then click on the yellow underline beneath the word of interest to receive a menu of links to web resources, e.g., advertisements. In an alternative embodiment, the user may press the ALT key while clicking on the word of interest if the word does not have a yellow underline beneath it in order to receive, if any, a menu of links to web resources, e.g., advertisements, related to the selected word. In order for the user to receive a menu of links to web resources, e.g., advertisements, the user must select the word or yellow underline beneath the word in the document read. However, the user may desire to receive advertisements and/or specific information related to the content of the user's focus, which may not be a particular word, but the content of a particular area within the document. Furthermore, the user may desire to receive advertisements and/or specific information related to the content of the user's focus without having to manually select a word of interest. It would therefore be desirable to transfer advertisements and/or specific information related to the content of a user's focus via a network without the user selecting a particular word of interest. Method 500 is a method for transferring advertisements and/or specific information related to the content of a user's focus via a network without the user selecting a particular word of interest.

In step 501, server 130 may transmit a file such as a markup language file, e.g., HyperText Mark-up Language (HTML) file, Extended Markup Language (XML) file, to a user of client 110. In the source code of a markup language, images, video and audio may be specified in various files of different formats. The file may then be parsed by web browser 111 (FIG. 1) in order to display the images and graphics on display 338 (FIG. 3) as well as generate audio through speakers 330 (FIG. 3) in step 502. In step 503, the document including text and/or images and/or graphics associated with the file received in step 501 may be displayed on display 338 and any audio, if any, associated with the file received in step 501 may be generated through speakers 330.

In step 504, server 130 may transmit an application 132 (FIG. 1) that may comprise a Java applet to web browser 111 of client 110. In another embodiment, server 210 may transmit an application 132 (FIG. 2) that may comprise a Java applet to web browser 111 of client 110. In one embodiment, application 132 may be downloaded as a plug-in to browser 111 of client 110. Application 132 may be configured to provide functionality to the document viewed as discussed further below. In one embodiment, application 132 may be further configured to store a list of one or more components, e.g., terms, in the document, e.g., web page, picture, displayed on display 338 in step 503 related to an advertisement and/or specific information. Application 132 may store the list of one or more components locally or remotely to server 130. In another embodiment, application 132 may store the list of one or more components in database 220 maintained by server 210.

In step 505, application 132 may be configured to track the focus of the user of client 110 in the document, e.g., web page, picture, displayed in step 503. In one embodiment, application 132 may embody code to perform tracking based on the movement of a mouse 326 (FIG. 3). In another embodiment, application 132 may embody code to perform tracking based on the area of text that may be zoomed by the user of client 110 using screen magnification software stored locally on client 110, e.g., screen magnification software stored in application 350 (FIG. 3). In another embodiment, application 132 may embody code to perform tracking based on a CCD camera 360 (FIG. 3). In another embodiment, application 132 may embody code to perform tracking based on CCD camera 360 and eye tracking software stored locally on client 110, e.g., eye tracking software stored in application 350. It is noted that there may be other means of tracking the focus of the user of client 110 and that the above are illustrative. It is further noted that other means of tracking the focus of the user of client 110 would be recognized by an artisan of ordinary skill in the art and that embodiments employing such means would fall within the scope of the present invention.

In step 506, application 132 may detect the user of client 110 focusing on a portion, for example a particular area or a particular word(s), in the document, e.g., web page, picture, displayed on display 338 in step 503. In one embodiment, application 132 may determine that the user of client 110 is focusing on a portion of in the document based on the user focusing on the portion in the document for a particular duration of time. For example, if the user of client 110 focuses on a portion for a particular duration of time, e.g., 10 seconds, then application 132 may determine that user of client 110 is focusing on that portion. In another embodiment, application 132 may determine that the user of client 110 is focusing on a portion in the document based on the user of client 110 zooming on the portion using screen magnification software stored locally on client 110, e.g., screen magnification software stored in application 350.

In step 507, application 132 may be configured to search through the list of one or more components, e.g., terms, stored locally or remotely to server 130 to determine if there are components in the portion focused on by the user of client 110 that are in the list. In another embodiment, application 132 may be configured to search through the list of one or more components, e.g., terms, stored in database 220 to determine if there are components in the portion focused on by the user of client 110 that are in the list. In step 508, a determination may be made as to whether there are any components in the portion focused on by the user of client 110 that are in the list. If there is not a component, e.g., term, in the portion focused on by the user of client 110 in the list, then application 132 may be configured to continue to track the focus of the user of client 110 in step 505.

If there are one or more components, e.g., terms, in the portion focused on by the user of client 110 in the list, then application 132 may identify those one or more components in the portion focused on by the user of client 110 in the list in step 509. In step 510, application 132 may map each of the identified one or more components, e.g., terms, to a particular file storing selected information associated with the portion focused on by the user. Such selected information may include advertising related to the portion or other selected information related thereto. For example, a prompt may be sent to the user that advises the user that additional information is available and queries the user if the user wants to receive the additional information. Note that such selected information may encompass any contextually related information including educational information. For example, if a user focuses on a particular word, which may indicate the user does not understand the word, a prompt to a dictionary may be provided. Likewise, a focus on a date may be related to historical information associated with that date. A user focus on an area in a web document reporting economic news might be associated with selected stock quotes or market index quotes. Those of ordinary skill would appreciate that the foregoing are exemplary and embodiments in accordance with the present inventive principles are not predicated or particular types of selected information. In one embodiment, one or more files storing such selected information may be stored in a table or a database located locally or remotely to server 130 or in database 220 maintained by server 210.

In step 511, application 132 may be further configured to transmit a request to server 130 to transmit the particular file(s) identified in step 510 to the user of client 110. In another embodiment, application 132 may be further configured to transmit a request to server 210 to transmit the particular file(s) identified in step 510 to the user of client 110. In step 512, server 130 may be configured to transmit the particular file(s) storing selected information identified in step 510 to client 110. In another embodiment, server 210 may be configured to transmit the particular file(s) storing the selected information identified in step 510 to client 110.

In step 513, the particular file(s) received in step 512 may be parsed by web browser 111 in order to display the images and graphics on display 338 as well as generate audio, if any, through speakers 330. The images and graphics as well as any audio are advertisement(s) and/or specific information related to the content of a user's focus. In step 514, the images and graphics of the received file(s) in step 512 may be displayed on display 338 and any audio, if any, of the received file(s) in step 512 may be generated through speakers 330.

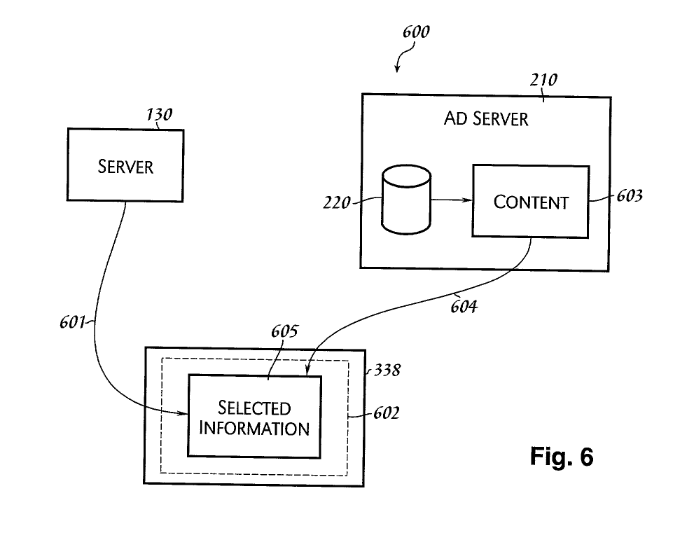

It is noted that method 500 may be executed in a different order presented and that the order presented in the discussion of FIG. 5 is illustrative. It is further noted that certain steps may be executed almost concurrently. It is further noted that steps 502-503 and 513-514 may be implemented by web browser 111 residing in application 350 or disk unit 320. It is further noted that steps 501 and 504-512 may be implemented by a program in server 130 residing in application 450 (FIG. 4) or disk unit 420 (FIG. 4) where the program transfers application 132 that may comprise a Java applet to client 110 to implement steps 505-511. It is further noted that step 501 may be implemented by a program in server 130 and steps 504-512 may be implemented by a program in server 210 residing in application 450 or disk unit 420 where the program transfers application 132 that may comprise a Java applet to client 110 to implement steps 505-511 as illustrated in a flow diagram 600 in FIG. 6.

### FIG. 6—Flow Diagram

FIG. 6 illustrates an embodiment of the present invention of a flow diagram 600 for transferring advertisement(s) and/or specific information related to the content of user's focus using the embodiment of FIG. 2. As stated above, server 130 may transmit a file to a user of client 110 as indicated by arrow 601. The file may be parsed by web browser 111 in order to display the images and graphics such as on a web page 602 on display 338. Upon application 132 detecting the user of client 110 focusing on a portion in web page 602 as described above, application 132 may be configured to search through the list of one or more components, e.g., terms, stored in database 220 to determine if there are components in the portion focused on by the user of client 110 that are in the list. If there are one or more components, e.g., terms, in the portion focused on by the user of client 110 in the list, then application 132 may identify those one or more components in the portion focused on by the user of client 110 in the list. Application 132 may map each of the identified one or more components, e.g., terms, to a particular file storing an advertisement and/or specific information. The identified file(s) as illustrated by content 603 may be transmitted to client 110 by server 210 as illustrated by arrow 604. The particular file(s) received may be parsed by web browser 111 in order to display the images and graphics, i.e., the advertisement(s) and/or specific information 605, such as in web page 602 on display 338.

Although the system, computer program product and method are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for transferring selected information over a network comprising of:
transmitting at least a portion of a document to be displayed to a user;
transmitting an application to the user, wherein said application is configured to track a focus of the user in said document, wherein said application is further configured to detect the user focusing on the portion of the document; and
transmitting selected information associated with the portion focused on by the user.

2. The method as recited in claim 1, wherein said application is further configured to search a list of one or more components, wherein the list of one or more components include components in said document associated with the selected information, and wherein said application is further configured to identify in the list one or more components in the portion focused on by the user.

3. The method as recited in claim 2, wherein said application is further configured to map the components in the portion focused on by the user identified in the list with one or more files storing the selected information associated with said one or more components identified in the list.

4. The method as recited in claim 3, wherein said application is further configured to transmit a request to transmit said one or more files over said network to the user.

5. The method as recited in claim 4 further comprising of:
transmitting said one or more files over said network to the user; and
displaying the selected information associated with the one or more components identified in the list.

6. The method as recited in claim 1, wherein the selected information associated with the portion comprises advertising.

7. The method as recited in claim 5, wherein audio associated with the selected information associated with said one or more components identified in the list is generated for outputting to the user.

8. The method as recited in claim 1, wherein said application comprises a Java applet.

9. The method as recited in claim 1, wherein said application is further configured to search a list of one or more components, wherein the list of one or more components include components in said document associated the selected information, wherein said application is further configured to determine whether any components in said portion focused on by the user are in the list.

10. The method as recited in claim 9, wherein said application is further configured, if no components in the portion focused on by the user are in the list, to track said focus of the user in said document.

11. A computer program product embodied in a machine readable medium for transferring selected information comprising the programming steps of:
transmitting at least a portion of a document to be displayed to a user;
transmitting an application to the user, wherein said application is configured to track a focus of the user in said document, wherein said application is further configured to detect the user focusing on the portion of the document; and
transmitting selected information associated with the portion focused on by the user.

12. The computer program product as recited in claim 11, wherein said application is further configured to search a list of one or more components, wherein the list of one or more components include components in said document associated with the context selected information, wherein said application is further configured to identify in the list one or more components in said portion focused on by the user.

13. The computer program product as recited in claim 12, wherein said application is further configured to map the components in the portion focused on by the user identified in the list with one or more files storing the selected information associated with said one or more components identified in the list.

14. The computer program product as recited in claim 13, wherein said application is further configured to transmit a request to transmit said one or more files over said network to the user.

15. The computer program product as recited in claim 14 further comprises the programming steps of:
transmitting said one or more files over said network to the user; and
displaying the selected information associated one or more components identified in the list.

16. The computer program product as recited in claim 11, wherein the selected information associated with the portion comprises advertising.

17. The computer program product as recited in claim 15, wherein audio associated with the selected information associated with said one or more components identified in the list is generated for outputting to the user.

18. The computer program product as recited in claim 11, wherein said application comprises a Java applet.

19. The computer program product as recited in claim 11, wherein said application is further configured to search a list of one or more components, wherein the list of one or more components include components in said document associated the selected information, wherein said application is further configured to determine whether any components in said portion focused on by the user are in the list.

20. The computer program product as recited in claim 19, wherein said application is further configured, if no components in the portion focused on by the user are in the list, to track said focus of the user in said document.

21. A system, comprising:
a memory unit operable for storing a computer program for transferring selected information over a network; and
a processor, responsive to said computer program, including:
circuitry operable for transmitting at least a portion of a document to be displayed to a user;
circuitry operable for transmitting an application to the user, wherein said application is configured to track a focus of the user in said document, wherein said application is further configured to detect the user focusing on the portion in said document; and
circuitry operable for transmitting selected information associated with the portion by the user.

22. The system as recited in claim 21, wherein said application is further configured to search a list of one or more components, wherein the list of one or more components include components in said document associated the selected information, wherein said application is further configured to identify in the list one or more components in said portion focused on by the user.

23. The system as recited in claim 22, wherein said application is further configured to map the one or more components in said portion focused on by the user identified in the list with one or more files storing the selected information associated with the one or more components identified in the list.

24. The system as recited in claim 23, wherein said application is further configured to transmit a request to transmit said one or more files over said network to the user.

25. The system as recited in claim 24, wherein said processor further comprises:
circuitry operable for transmitting said one or more files over said network to the user; and
circuitry operable for displaying the selected information associated with the one or more components identified in the list.

26. The system as recited in claim 25, wherein the selected information comprises advertising.

27. The system as recited in claim 25, wherein audio associated the selected information associated with said one or more components identified in the list is generated for outputting to the user.

28. The system as recited in claim 21, wherein said application comprises a Java applet.

29. The system as recited in claim 21, wherein said application is further configured to search a list of one or more components, wherein the list of one or more components include components in said document associated with the selected information, wherein said application is further configured to determine whether any components in said portion focused on by the user are in the list.

30. The system as recited in claim 29, wherein said application is further configured, if no components in the portion focused on by the user are in the list, to track said focus of the user in said document.
